(19) United States
(12) Patent Application Publication
(10) Pub. No.: US 2003/0025724 A1
(43) Pub. Date: Feb. 6, 2003

(54) Transmitting Web pages in a plurality of alternate readable modes selectable to direct users having different reading skills to read along a world wide Web page

(75) Inventors: Cristi Nesbitt Ullmann, Austin, TX (US); Lorin Evan Ullmann, Austin, TX (US)

Correspondence Address: International Business Machines Corporation, Intellectual Property Law Department, Internal Zip 4054, 11400 Burnet Road, Austin, TX, 78758, US

(73) Assignee: International Business Machines Corporation, Armonk, NY (US)

(21) Appl. No.: 09/845,464

(22) Filed: Apr. 30, 2001

(51) Int. Cl. G06F 13/00; G06F 3/00

(52) U.S. Cl. 345/707; 345/764

(57) ABSTRACT

A system for directing users of varying and particularly limited reading skills through a reading of a received Web page which helps such users to ignore Web page clutter and focus on the page content direction. The Web page is transmitted in a plurality of selectable readable modes; at least one of which modes includes a movable indicator directing the user to read along the Web page in a predetermined orthogonal progressive pattern. The movable indicator is preferably an element highlighting a sequential block of data. For example, the highlighted block of data may be brighter than the other data on the Web page or have a color different from the color of the other data on the Web page. The Web page is transmitted over the Web in a markup language comprising control tags enabling the Web page to be selectively read in said moving indicator mode and there is a Web browser at said receiving Web station for selectively reading said received Web page in said moving indicator mode.

### TECHNICAL FIELD

The present invention relates to computer managed communication networks such as the World Wide Web (Web) and, particularly, to systems, processes and programs for directing users of different reading skills in reading through Web pages.

### BACKGROUND OF RELATED ART

The past decade has been marked by a technological revolution driven by the convergence of the data processing industry with the consumer electronics industry. The effect has, in turn, driven technologies which have been known and available but relatively quiescent over the years. A major one of these technologies is the Internet or Web related distribution of documents, media and programs. The convergence of the electronic entertainment and consumer industries with data processing exponentially accelerated the demand for wide ranging communication distribution channels, and the Web or Internet, which had quietly existed for over a generation as a loose academic and government data distribution facility, reached “critical mass” and commenced a period of phenomenal expansion. With this expansion, businesses and consumers have direct access to all matter of documents, media and computer programs.

In addition, Hypertext Markup Language (HTML), which had been the documentation language of the Internet or Web for years, offered direct hyperlinks between Web pages embedded in such Web pages. This even further exploded the use of the Internet or Web.

As a result of these changes, it seems as if virtually all aspects of human endeavor in the industrialized world require human-computer interfaces. These changes have made computer directed activities accessible to a substantial portion of the industrial world's population which, up to a few years ago, was computer-illiterate, or, at best, computer indifferent. Although Web documents or pages in languages other than English are available via the Web, English has become the predominant language of the Web. Consequently, there are millions of people accessing Web pages in English who have limited reading skills in the English language of the Web.

In addition, computer controlled communications networks, such as the Web, have been significant in expanding work opportunities for visually and physically impaired people. The computer may be tailored to the unique abilities of each visually or physically impaired individual. To this end the computer industry is continuously seeking new implementations to bring more and more visually and physically impaired individuals into full productivity in the work force.

Unfortunately, the layout and content of current Web or Internet (the two terms are used interchangeably herein) pages works against ease of use by the physically impaired and, particularly, the visually impaired. The display screens on which Web pages are presented to the user usually has a great amount of “clutter” surrounding and intruding into the content of the Web page itself. There are usually text and images left over from previous pages at various prior browsing levels. There is advertising going off in all directions on the page. Also, with Web pages, we do not have the situation of a relatively small group of professional designers working out the human factors. Although a great many Web pages are communicative and well laid out, in actuality anyone and everyone can design a Web page. As a result, Web pages are frequently set up and designed in an eclectic manner and have the clutter described above. Thus, on the Web page display screen it is difficult and frustrating, particularly for people with physical, visual and reading limitations to ignore all of the clutter and concentrate on directing their reading through the intended content of the Web page.

### SUMMARY OF THE PRESENT INVENTION

The present invention is directed to a unique Web page function, i.e. a system and program for directing users of varying and particularly limited reading skills through a reading of a received Web page which helps such users to ignore Web page clutter and focus on the direction and flow of the page content. The Web page is transmitted in a plurality of selectable readable modes, at least one of which modes includes a movable indicator directing the user to read along the Web page in a predetermined orthogonal progressive pattern. The movable indicator is preferably an element highlighting a sequential block of data. For example, the highlighted block of data may be brighter than the other data on the Web page or have a color different from the color of the other data on the Web page. The Web page is transmitted over the Web in a markup language comprising control tags enabling the Web page to be selectively read in said moving indicator mode, and there are means at said receiving Web station for selectively reading said received Web page in said moving indicator mode. The means for reading the Web page in any of a variety of indicator modes is preferably in a Web browser associated with the receiving Web station.

The dimensions of the indicator element may be selectively varied. The speed at which the indicator element progressively moves along said page to direct the reading of the user may also be selectively varied. Also, text within the moving indicator block may be enlarged in size to help visually impaired users.

In accordance with another aspect of the invention, a plurality of the movable indicators may be simultaneously used so that each of the highlighted blocks of data within each of said plurality of indicators has a color respectively different from the blocks of data within the other indicators.

The Web page is customarily transmitted in Hypertext Markup Language and includes text. In Web pages including text, the highlighted block may be a grammatical unit. Also, where a plurality of highlighted blocks are used, a different type of grammatical unit may be in each block, e.g. subject, verb and predicate.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a generalized data processing system including a central processing unit which provides the computer controlled interactive display system which may be used in practicing the present invention;

FIG. 2 is a generalized diagrammatic view of a Web portion upon which the present invention may be implemented;

FIG. 3 is a diagrammatic view of a typical Web page displayed at a receiving display station;

FIG. 4 is the diagrammatic Web page view of FIG. 3, after a user has decided to read the Web page with the aid of a movable indicator in accordance with the present invention and has brought up a menu of selectable indicators;

FIG. 5 is the Web page view of FIG. 4 wherein the user has chosen to read the Web page in a mode wherein the highlighted indicator block is a text sentence unit;

FIG. 6 is the Web page view of FIG. 5 indicating the reader indicator progression to the next sentence;

FIG. 7 is the Web page view of FIG. 4 wherein the user has chosen to read the Web page in a mode wherein the highlighted indicator block increases the size of, i.e. enlarges, the text;

FIG. 8 is the Web page view of FIG. 4 wherein the user has chosen to read the Web page in a mode wherein a plurality of highlighted indicator blocks are used;

FIG. 9 is an illustrative flowchart describing the setting up of the process of the present invention for providing movable indicators directing users through the content of the Web page; and

FIG. 10 is a flowchart of an illustrative run of the process setup in FIG. 9.

### DETAILED DESCRIPTION OF THE PREFERRED EMBODIMENT

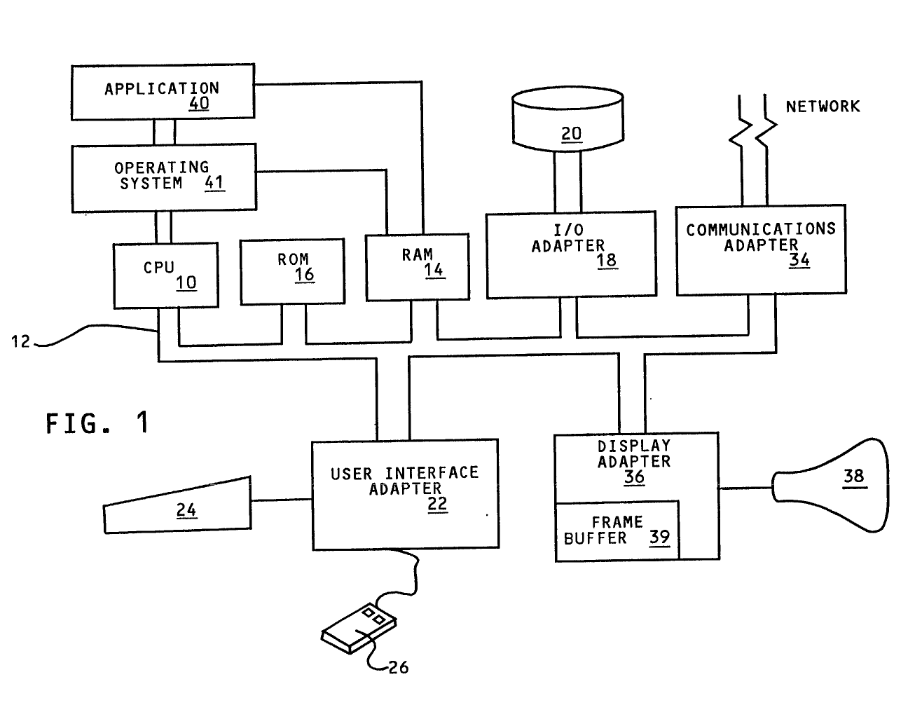

Referring to FIG. 1, a typical data processing terminal is shown which may function as the Web display stations used for receiving Web pages, for requesting Web searches and for Web browsing.

A central processing unit (CPU) 10, such as one of the PC microprocessors or workstations, e.g. RISC System/6000™ (RS/6000) series available from International Business Machines Corporation (IBM), is provided and interconnected to various other components by system bus 12. An operating system 41 runs on CPU 10, provides control and is used to coordinate the function of the various components of FIG. 1. Operating system 41 may be one of the commercially available operating systems such as the AIX 6000™ operating system available from IBM; Microsoft's Windows 98™ or WindowsNT™, as well as UNIX and AIX operating systems. Application programs 40, controlled by the system, are moved into and out of the main memory Random Access Memory (RAM) 14. These programs include the programs of the present invention for providing to the Web page user a plurality of selectable modes for reading the Web using movable indicators for directing the Web page content to be read in a predetermined orthogonal direction. The programs will be subsequently described in combination with any conventional Web browser, such as the Netscape Navigator 3.0™ or Microsoft's Internet Explorer™. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside network enabling the data processing system to communicate with other such systems over a Local Area Network (LAN) or a Wide Area Network (WAN), which includes, of course, the Web or Internet. The latter two terms are meant to be generally interchangeable and are so used in the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to Web pages. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods which may be related to the present invention. Since the major aspect of the present invention is directed to Web pages transmitted over global networks, such as the Web or Internet, an understanding of networks and their operating principles would be helpful. We will not go into great detail in describing the networks to which the present invention is applicable. For details on Web nodes, objects and links, reference is made to the text, Mastering the Internet, G. H. Cady et al., published by Sybex Inc., Alameda, Calif., 1996; or the text, Internet: The Complete References Millennium Edition, Margaret Young et al., Osborne/McGraw-Hill, Berkeley, Calif., 1999. Any data communication system which interconnects or links computer controlled systems with various sites defines a communications network. Of course, the Internet or Web is a global network of a heterogeneous mix of computer technologies and operating systems. Higher level objects are linked to the lower level objects in the hierarchy through a variety of network server computers.

Web documents are conventionally implemented in markup languages such as the HTML language, which is described in detail in the text entitled Just Java, van der Linden, 1997, SunSoft Press, particularly at Chapter 7, pp. 249-268, dealing with the handling of Web pages; and also in the above-referenced Mastering the Internet, particularly pp. 637-642, on HTML in the formation of Web pages. As will be further described hereinafter, the Web owner or Web page designer, through the inclusion of appropriate control tags, may provide the user receiving the Web with the option of reading the page in any of plurality of modes most suited to the users reading skills.

In addition, aspects of this invention will involve Web browsers. A general and comprehensive description of browsers may be found in the above-mentioned Mastering the Internet text at pp. 291-313. More detailed browser descriptions may be found in the above-mentioned Internet: The Complete Reference, Millennium Edition text, Chapter 19, pp. 419-454, on the Netscape Navigator; Chapter 20, pp. 455-494, on the Microsoft Internet Explorer; and Chapter 21, pp. 495-512, covering Lynx, Opera and other browsers.

Web pages are generally located on the Web through search engines. As described in the above-mentioned Internet: The Complete Reference, Millennnium Edition text, pages 395 and 522-535, search engines use keywords and phrases to query the Web for desired subject matter. The search engine usually uses a search agent called a “spider” that looks for information on Web pages. Such information is indexed and stored in a vast database. In carrying out its search, the search engine looks through the database for matches to keywords subject to the engine syntax. The search engine then presents to the user a list of the Web pages it determines to be closest to the requested query. Some significant search engines are: AltaVista, Infoseek, Lycos, Magellan, Webcrawler and Yahoo.

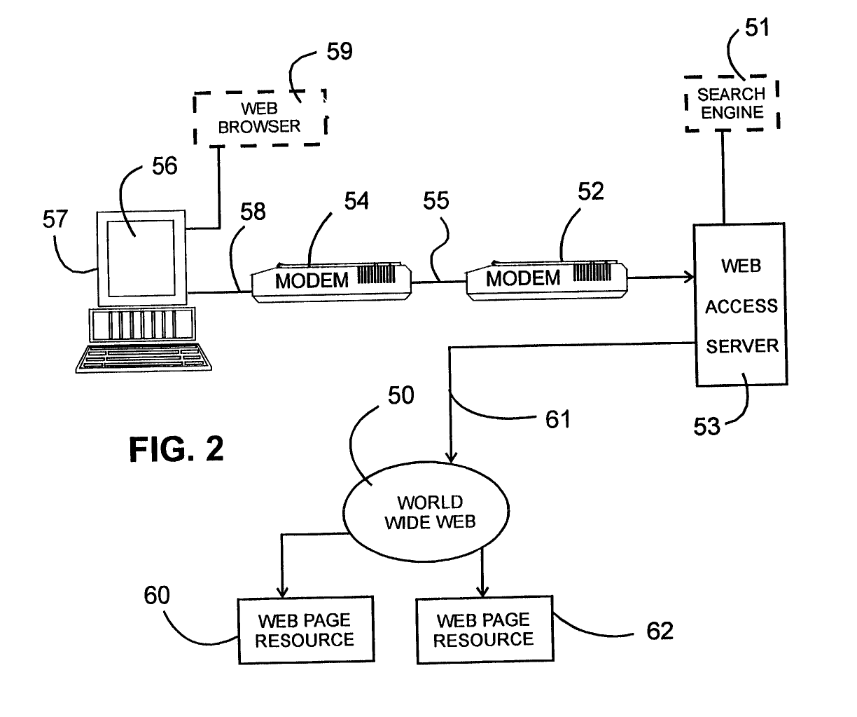

A generalized diagram of a portion of the Web to which the computer controlled display terminal 57 used for Web page receiving during searching or browsing is connected as shown in FIG. 2. Computer display terminal 57 may be implemented by the computer system setup in FIG. 1 and connection 58 (FIG. 2) is the network connection shown in FIG. 1. For purposes of the present embodiment, computer 57 serves as a Web display station and has received displayed Web page 56. Reference may be made to the above-mentioned Mastering the Internet, pp. 136-147, for typical connections between local display stations to the Web via network servers, any of which may be used to implement the system on which this invention is used. The system embodiment of FIG. 2 has a host-dial connection. Such host-dial connections have been in use for over 30 years through network access servers 53 which are linked 61 to the Web 50. The servers 53 may be maintained by a service provider to the client's display terminal 57. The host's server 53 is accessed by the client terminal 57 through a normal dial-up telephone linkage 58 via modem 54, telephone line 55 and modem 52. The HTML file representative of the Web page 56 has been downloaded to display terminal 57 through Web access server 53 via the telephone line linkages from server 53, which may have accessed them from the Internet 50 via linkage 61. The Web browser program 59 operates within the display terminals 57 to control the communication with the Web access server 53 to thereby download and display the accessed Web pages 56 on terminal 57. The Web access server 53 uses one of the previously described search engines 51 to access via the Web 50 the desired sequence of Web pages from appropriate Web resources, such as databases 60 and 62.

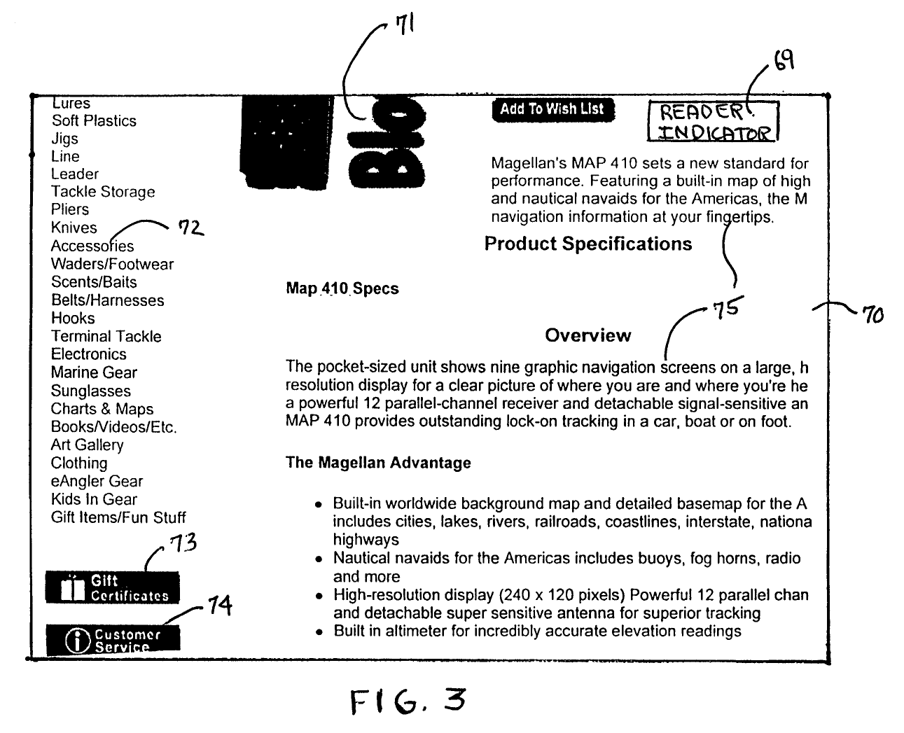

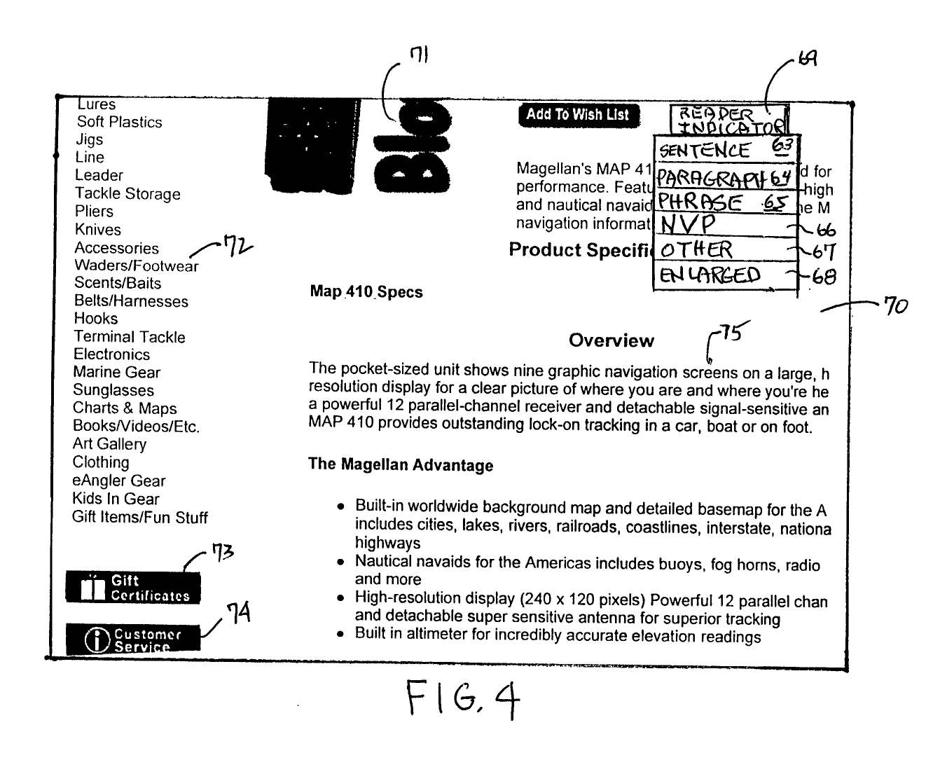

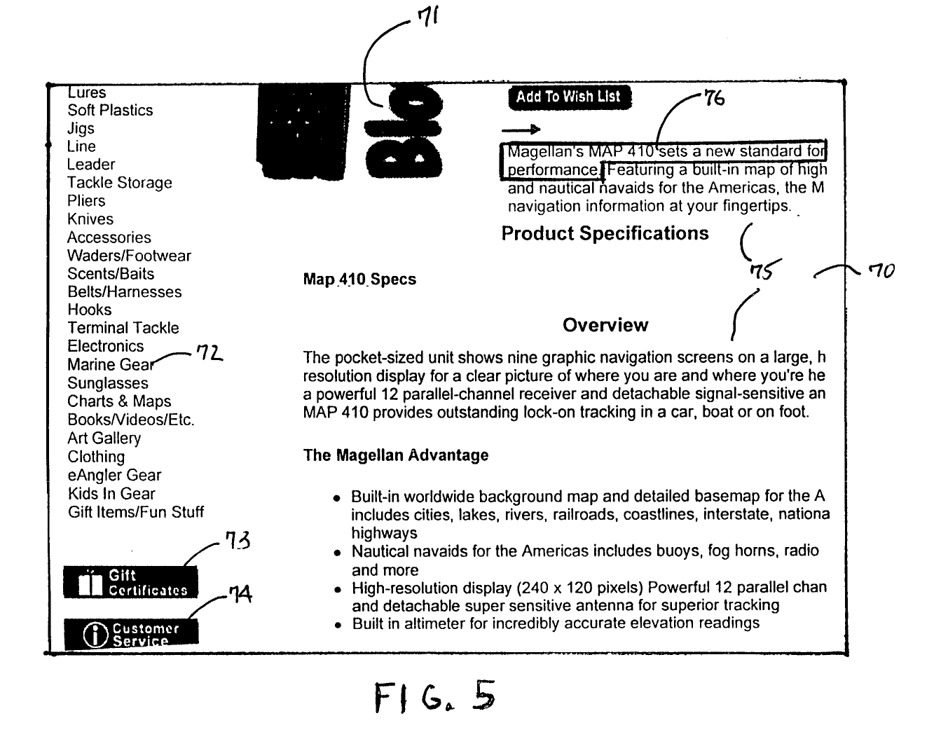

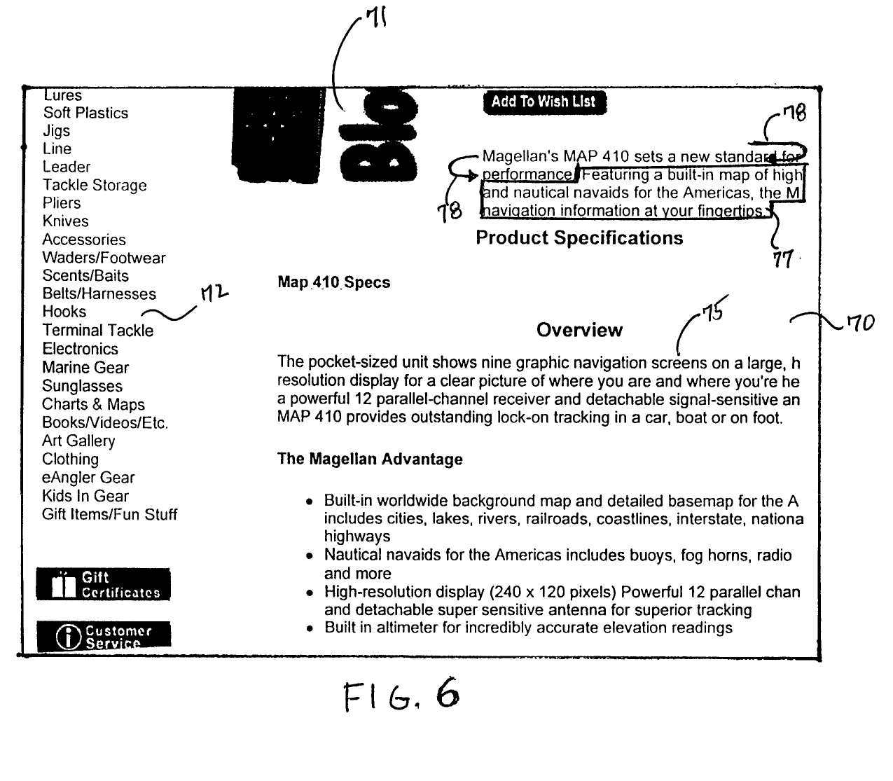

With this setup, the present invention, which will be subsequently described in greater detail with respect to FIGS. 3 through 8, may be carried out using Web browser 59. Search engine 51 accesses the sequence of Web pages and provides such pages to the user at terminal 57. FIG. 3 shows a Web page 70 conventionally displayed on screen 56 of terminal 57. In addition to the actual content 75 of the Web page, the screen is cluttered with text and image extraneous to the content 75. For example, there is: a segment of a Web advertisement 71; an independent listing 72 of hyperlinks to a wide variety of subject matter which has nothing to do with the content 75 of the page 70; a link 73 to get Gift Certificates; and a link 74 to Customer Service. Actually, for purposes of clearly illustrating the present invention, the clutter has been reduced. On the typical Web page there may be left over frames and segments from previous Web pages at different browser levels. In any event, if the user chooses to use an alternative mode of the Web page 70 which provides a movable indicator to focus and direct the reading of the pertinent page content 75 and the Web page designer has provided such alternate modes, the user may click on the “READER INDICATOR” button 69. This will result in the listing shown in FIG. 4 that sets forth a menu of the alternate page reader modes, 63 through 68, provided by the Web page designer, i.e. where the movable highlighting indicator is: a sentence block 63; a paragraph block 64; a phrase block 65; NVP 66—a sequence of three blocks respectively defining the Noun, Verb and Predicate; a block within which the text content has an enlarged character size 68; as well as any other mode 67 provided by the Web page designer. In this illustration, the user has selected the Web page mode wherein the moving highlighting block indicator has defined a grammatical unit of sentence size 76 as shown in FIG. 5 with the reader moving in the direction shown by the arrow. Accordingly, the reader indicator block 77 moves to the next sentence as shown in FIG. 6 in the wrap around orthogonal left to right and down direction as indicated by arrows 78.

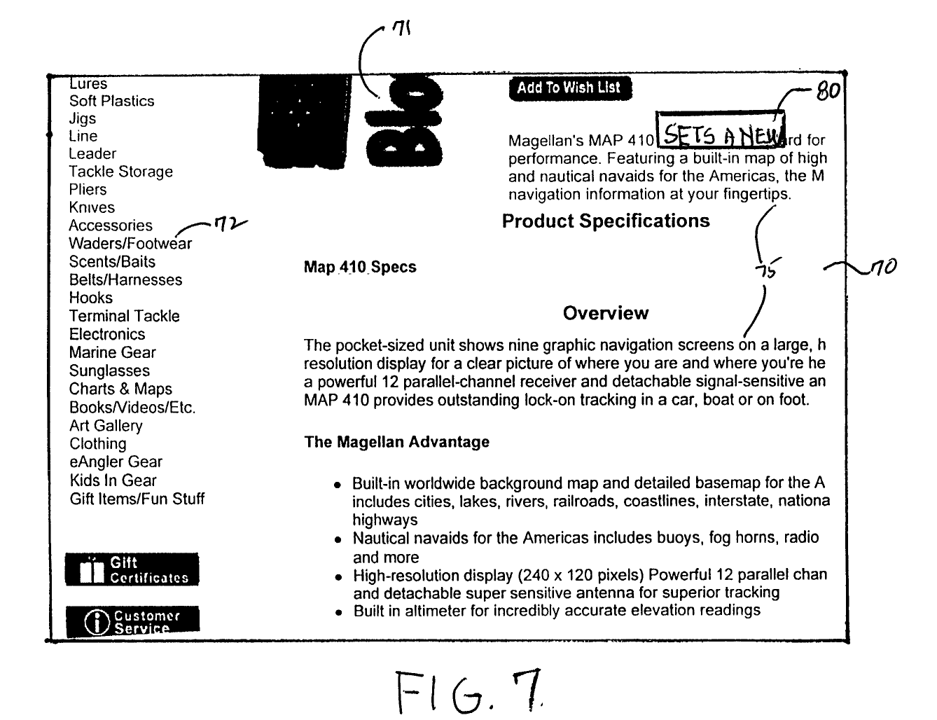

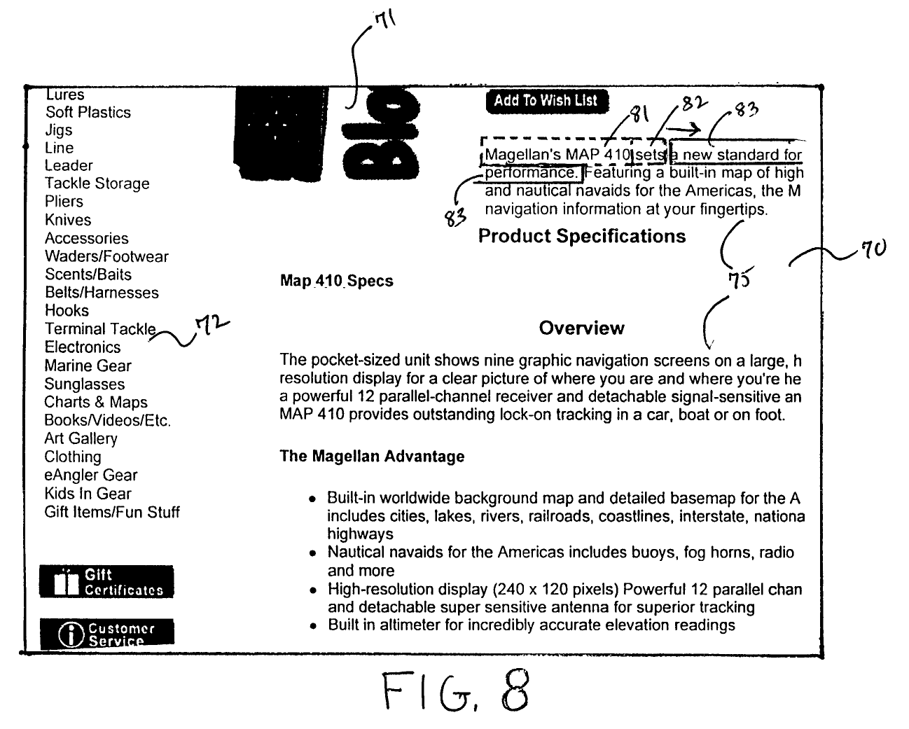

If the user selects the “Enlarged” 68 Web read mode item from the menu in FIG. 4, the result is the movable reader block indicator shown in FIG. 7 wherein the text within indicator block 80 is enlarged or magnified as a further aid to the user of limited reading skills who is being directed through the Web page. On the other hand, if the user selects the “NVP” 66 item (Noun-Verb-Predicate) from the menu in FIG. 4, the result is the multicolored block indicators shown in FIG. 8 in which the indicator block 81 defining the subject in the sentence is of a first color; the indicator block 82 defining the verb in the sentence is of a second color; and indicator block 83 defining the predicate in the sentence is of a third color. These three blocks will move sequentially one after another, sentence by sentence in the left to right and down orthogonal direction described hereinabove with respect to FIGS. 5 and 6. At the exact point in the reading shown in FIG. 8, the colored blocks 81 and 82 respectively defining the subject and the verb have already been passed as indicated by their block outline being in dashed lines, and the block indicator 83 defining the predicate is the current reading point.

As set forth above, the text within the reader indicator block may be distinguished from the remainder of the data on the Web page by either differences in brightness or differences in color. In the case of multiple indicators as described above with respect to FIG. 8, then, in addition, these indicators may be distinguished from each other also by differences in color.

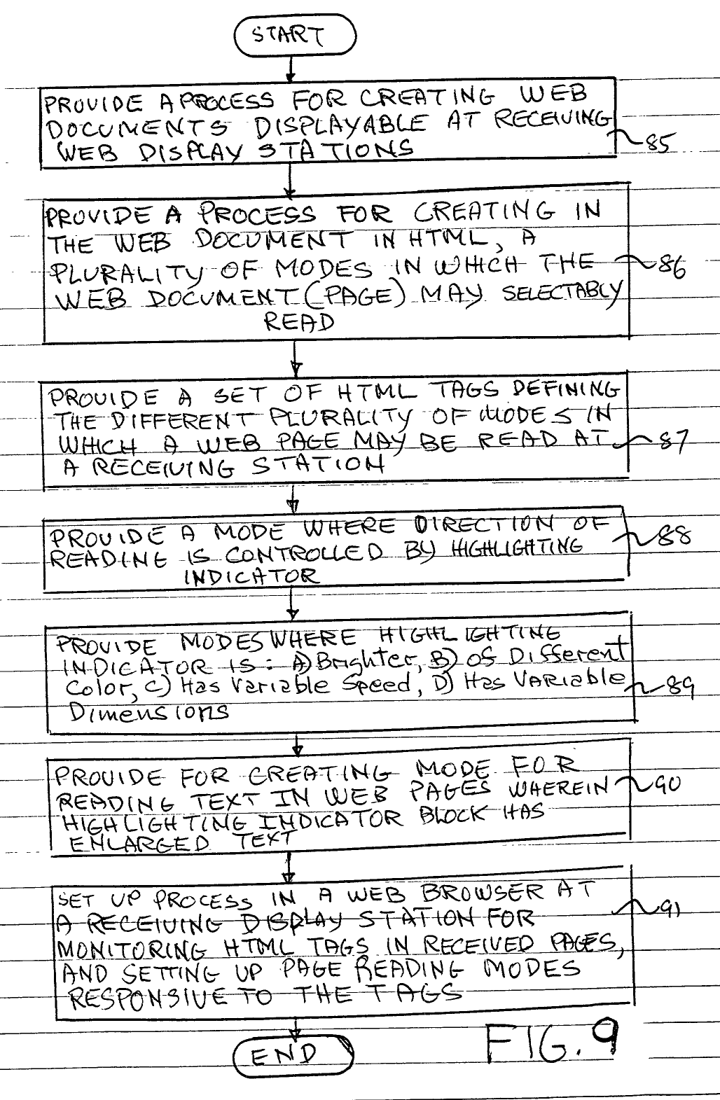

FIG. 9 is a flowchart showing the development of a process according to the present invention for creating, transmitting and displaying Web pages in a plurality of selectable modes for directing users of varying reading skills through a progressive reading of a Web page controlled by a movable highlighting indicator in a predetermined progressive orthogonal pattern. Most of the programming functions in the process of FIG. 9 have already been described in general with respect to FIGS. 3 through 8. A process is provided for rendering Web pages at receiving Web display stations, step 85. A process is provided to enable the creators and designers of Web pages in HTML to create a number of modes in which the Web page may selectably be read, step 86. New HTML tags are provided for HTML documents to define the mode in which the Web page is to be read at the receiving Web station, step 87. Among the read modes in which the Web page may be created is a mode where the direction of reading is controlled by a highlighting indicator, step 88. Among the read modes in which the Web page may be created are modes where the highlighting indicator is: A) brighter, B) of different color, C) has a variable speed, or D) variable dimensions, step 89. Web pages are enabled to be created in a mode for reading text in Web pages wherein the text in the highlighted indicator block is enlarged so as to be easier to read, step 90.

Finally, there is set up a process in a Web browser at a receiving display station for monitoring and decoding the new HTML tags in received Web pages and to set up the Web page reading modes required by the tags as selected by the user of the received Web page, step 91.

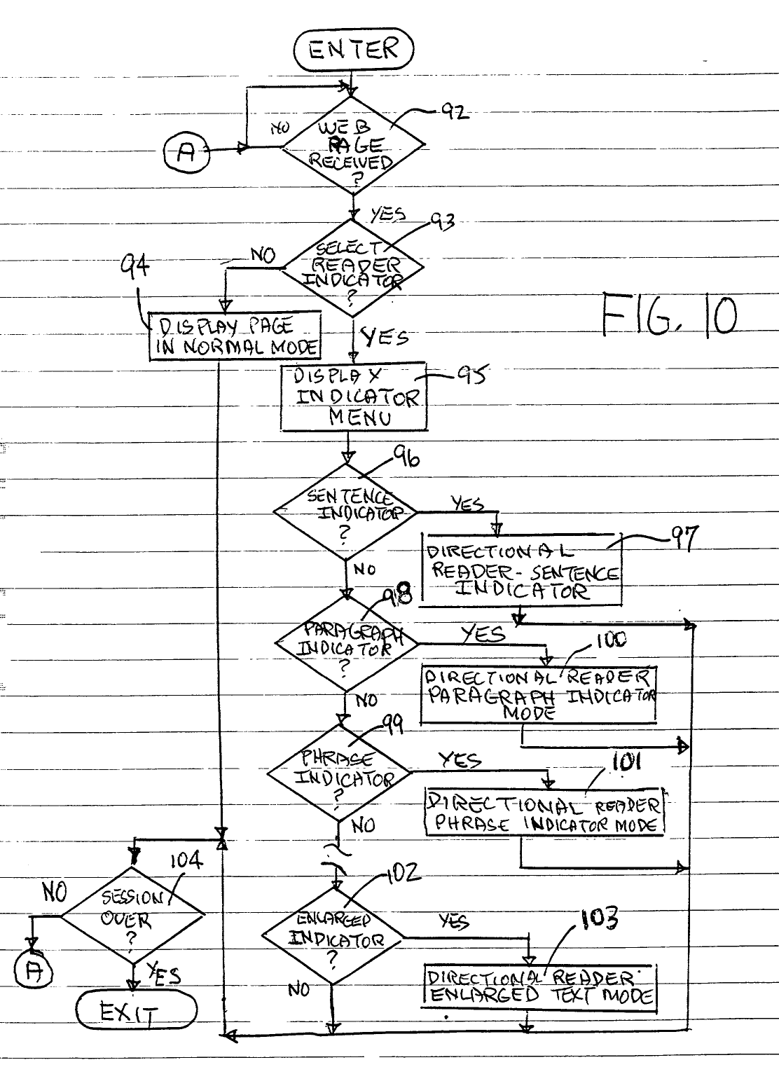

The running of the process set up in FIG. 9 and described in connection with FIGS. 3 through 8 will now be described with respect to the flowchart of FIG. 10. Let us assume that we are in a Web browsing session through the browser at the Web page receiving display station. The flowchart represents some steps in a routine that will illustrate the operation of the invention. Initially, a determination is made as to whether a Web page has been received, step 92. If No, the process is returned to step 92 and the arrival of the Web page ia awaited. If Yes, a further determination is made as to whether the user has selected to read the Web page in one of the Web page reader modes, step 93. If No, then the Web page continues to be displayed and used in the normal mode, step 94. If Yes, the user has selected to use one of the Web page reader modes, then, step 95, the menu of selectable Web page reading modes is displayed as shown in FIG. 4 so that the user may make his selection. Then the user makes one of the following selections: step 96, if he selects to use the sentence highlighter mode, the directional reader sentence indicator mode as shown in FIGS. 5 and 6 is used, step 97; then, step 98, if he selects to use the paragraph highlighter mode, the directional reader paragraph indicator mode is used, step 100; then, step 99, if he selects to use the phrase highlighter mode, the directional phrase paragraph indicator mode is used, step 101; and, step 102, if he selects to use the enlarged text highlighter mode, the directional reader enlarged indicator mode, as shown in FIG. 7, is used, step 103. After each of steps 94, 97, 100, 101 and 103 wherein a Web page is displayed either in the normal or special reading modes, a determination is made as to whether the session is over, step 104. If Yes, the session is exited. If No, the process is branched back to step 92 via branch “A” and the process is continued.

It has been indicated that it is the function of the Web page designers to provide the Web pages in the alternate reader modes that the user may select and have rendered through his Web browser. This function requires the inclusion of the reader variations in the HTML document representative of the Web which are then rendered by the Web browser into the natural language displayed Web page. Appropriate HTML tags identify the reader mode functions and trigger the browser to carry out the routines for directing the movement and extent of the indicator blocks for traversing the content of the Web page in the modes described above.

For example the Web browser could be triggered to respectively perform the functions respectively shown in FIG. 8 by the following HTML example to produce an output at the receiving station wherein the subject, verb and predicate indicator blocks each has a different color:

Content to be read:
The cat went in the house
New Markup Language:
</p><subject>The
Cat</subject><verb>went</verb><predicate>in the
house</predicate>
<attributes>
key=subject, color=red, outlineblock=false;
key=verb, color=green, outlineblock=false;
key=predicate, color=blue, outlineblock=true;
key=separation_of_sentence parts=3 spaces
key=separation_between_sentences=10 spaces (multiple
sentences allowed per line)
key=different_sentences_allowed_on_same_line=true
</attributes>

The resulting natural language output from the browser would be: The cat went in the house.

(Wherein, the subject, verb and predicate would be sequentially within indicator blocks of different colors.)

The following is an example of a generalized code sequence of the steps in a receiving station browser to render the reading of a Web page sequence in accordance with the markup example:

### Rendering of Web Page by Browser

Get Attributes of sentence Parts

For Subject

Store color

Store outline

. . . etc.

For Verb

Store color

Store outline

. . . etc.

For Predicate

Store color

Store outline

. . . etc.

Get Text From Markup Content

Get Starting Location for display (xleft,ytop) ofleft, top corner

For Each Sentence loop:

Get Subject from sentence
Read in Attributes
Create font object using attributes
Create string of subject with font
if (one sentence per line)

xnew=xleft;
ynew=ynew+1;
Draw subject string at (xnew,ynew);

else

xnew=xnew+sentence separation;
Draw subject string at (xnew,ynew);

Get Verb from sentence
Read in Attributes
Create font object using attributes
Create string of verb with font
if (one sentence per line)

xnew=xleft;
ynew=ynew+1;
Draw subject string at (xnew,ynew);

else

xnew=xnew+sentence separation;
Draw subject string at (xnew,ynew);

Get Predicate from sentence
Read in Attributes
Create font object using attributes
Create string of predicate with font
if (one sentence per line)

xnew=xleft;
ynew=ynew+1;
Draw subject string at (xnew,ynew);

else
xnew=xnew+sentence separation;
Draw subject string at (xnew,ynew);

In the above descriptions, the examples of Web page reading modes were directed to aid people of limited reading skills. The system of this invention may also be used as an aid for people of superior reading skills, e.g. speed readers. A great many speed reading systems rely on orthogonal scanning of the central core of the readable content in a very rapid left to right and down direction. Block highlighting indicators in accordance with the present invention can be created and carried out to enhance the efforts of speed readers.

One of the preferred implementations of the present invention is in application program 40, i.e. a browser program made up of programming steps or instructions resident in RAM 14, FIG. 1, of a Web receiving station during various Web operations. Until required by the computer system, the program instructions may be stored in another readable medium, e.g. in disk drive 20, or in a removable memory such as an optical disk for use in a CD-ROM computer input, or in a floppy disk for use in a floppy disk drive computer input. Further, the program instructions may be stored in the memory of another computer prior to use in the system of the present invention and transmitted over a LAN or a WAN, such as the Web itself, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In a World Wide Web (Web) network system including a plurality of computer controlled display Web stations for receiving Web pages transmitted over the Web, a system for directing users having different reading skills through a reading of a Web page received at a Web station comprising:
means for transmitting a Web page in a plurality of selectable readable modes; and
at least one of said readable modes including a movable indicator directing the user to read along the Web page in a predetermined orthogonal progressive pattern.

2. The Web network system of claim 1 wherein said indicator is an element highlighting a sequential block of data.

3. The Web network system of claim 2 wherein said highlighted block of data is brighter than the other data on the Web page.

4. The Web network system of claim 2 wherein said highlighted block of data has a color different from the color of the other data on the Web page.

5. The Web network system of claim 2 wherein:
the Web page is transmitted over the Web in a markup language comprising control tags enabling the Web page to be selectively read in said moving indicator mode; and
further comprising means at said receiving Web station for selectively reading said received Web page in said moving indicator mode.

6. The Web network system of claim 2 further including means for selectively varying the dimensions of said indicator element.

7. The Web network system of claim 2 further including means for selectively varying the speed at which the indicator element progressively moves along said page.

8. The Web network system of claim 2 further including means for selectively increasing the size of the data in said block relative to the remainder of data on said Web page.

9. The Web network system of claim 4 further including a plurality of said movable indicators wherein each of the highlighted blocks of data within each of said plurality of indicators has a color respectively different from the blocks of data within the other indicators.

10. The Web network system of claim 5 wherein said means at said receiving Web station for reading said Web page includes a Web browser.

11. The Web network system of claim 10 wherein said Web page is transmitted in Hypertext Markup Language.

12. The Web network system of claim 11 wherein:
said Web page includes text; and
said highlighted block of text is a grammatical unit.

13. In a Web network system including a plurality of computer controlled display Web stations for receiving Web pages transmitted over the Web, a method for directing users having different reading skills through a reading of a Web page received at a Web station comprising:
transmitting a Web page in a plurality of selectable readable modes; and
in at least one of said readable modes, enabling a movable indicator directing the user to read along the Web page in a predetermined orthogonal progressive pattern.

14. The method of claim 13 wherein said indicator is an element highlighting a sequential block of data.

15. The method of claim 14 wherein said highlighted block of data is made brighter than the other data on the Web page.

16. The method of claim 14 wherein said highlighted block of data is given a color different from the color of the other data on the Web page.

17. The method of claim 14 including the steps of:
transmitting the Web page over the Web in a markup language comprising control tags enabling the Web page to be selectively read in said moving indicator mode; and
selectively reading said received Web page in said moving indicator mode at said receiving Web station.

18. The method of claim 14 further including the step of selectively varying the dimensions of said indicator element.

19. The method of claim 14 further including the step of selectively varying the speed at which the indicator element progressively moves along said page.

20. The method of claim 14 further including the step of selectively increasing the size of the data in said block relative to the remainder of data on said Web page.

21. The method of claim 16 including the steps of:
enabling a plurality of said movable indicators; and
giving each of the highlighted blocks of data within each of said plurality of indicators a color respectively different from the blocks of data within the other indicators.

22. The method of claim 17 further including a Web browser process at said receiving Web station for reading said Web page.

23. The method of claim 22 wherein said Web page is transmitted in Hypertext Markup Language.

24. The method of claim 23 wherein:
said Web page includes text; and
said highlighted block of text is a grammatical unit.

25. A computer program having code recorded on a computer readable medium for directing users having different reading skills through a reading of a Web page received at a Web computer controlled display station comprising:
means for transmitting a Web page from a source on the Web in a plurality of selectable readable modes; and
at least one of said readable modes including a movable indicator directing the user to read along the Web page in a predetermined orthogonal progressive pattern.

26. The computer program of claim 25 wherein said indicator is an element highlighting a sequential block of data.

27. The computer program of claim 26 wherein said highlighted block of data is brighter than the other data on the Web page.

28. The computer program of claim 26 wherein said highlighted block of data has a color different from the color of the other data on the Web page.

29. The computer program of claim 26 wherein:
the Web page is transmitted over the Web in a markup language comprising control tags enabling the Web page to be selectively read in said moving indicator mode; and
further comprising means at said receiving Web station for selectively reading said received Web page in said moving indicator mode.

30. The computer program of claim 26 further including means for selectively varying the dimensions of said indicator element.

31. The computer program of claim 26 further including means for selectively varying the speed at which the indicator element progressively moves along said page.

32. The computer program of claim 26 further including means for selectively increasing the size of the data in said block relative to the remainder of data on said Web page.

33. The computer program of claim 28 further including a plurality of said movable indicators wherein each of the highlighted blocks of data within each of said plurality of indicators has a color respectively different from the blocks of data within the other indicators.

34. The computer program of claim 29 wherein said means at said receiving Web station for reading said Web page include a Web browser program.

35. The computer program of claim 34 wherein said Web page is transmitted in Hypertext Markup Language.

36. The computer program of claim 35 wherein:
said Web page includes text; and
said highlighted block of text is a grammatical unit.
